(19) United States
(12) Patent Application Publication
(10) Pub. No.: US 2002/0152319 A1
(43) Pub. Date: Oct. 17, 2002

(54) Accounting management support based on QOS in an IP centric distributed network

(76) Inventors: Rajesh B. Amin, DeSoto, TX (US); John Allahyari, Dallas, TX (US); Shaibal Chakrabarty, Richardson, TX (US); Mike Hall, Carrolton, TX (US)

Correspondence Address: David L. McCombs, Haynes and Boone, LLP, 901 Main Street, Suite 3100, Dallas, TX, 75202-3789, US

(21) Appl. No.: 09/779,724

(22) Filed: Feb. 8, 2001

(51) Int. Cl. G06F 15/16

(52) U.S. Cl. 709/232; 709/230

(57) ABSTRACT

This patent provides a system and method to support accounting management activities for multiple simultaneous applications or services based on their assigned quality of service (QoS). The system dynamically segments and aligns the billing along the lines of a dynamic QoS modification. This represents an advantage to the operator and allows for full compensation of network resource use. Requests for QoS changes cause changes in usage of network resources. Interactions between network components cause accounting management changes adjusted dynamically per user, and on invoked service basis. During static configuration, a default QoS is configured for each service based on the end user's subscriber information. Dynamic configuration for required QoS is performed upon service invocation. Moreover, an end user can request a change in QoS during service session to accommodate a temporary need of a different QoS. The end user may request change in QoS implicitly through service invocation to the allied application servers or explicitly to the network components directly. In any case, based on the subscribers' policy and network's preferences and policy, the QoS is configured.

### FIELD OF THE INVENTION

The invention relates generally to accounting management activities for computers and specifically, to an accounting architecture for an IP-centric distributed network that supports data and telecommunication services and a method and apparatus for such a network.

### BACKGROUND OF THE INVENTION

A majority of telecommunication networks today are non-distributed, tightly coupled, proprietary, circuit-based, voice-centric, and connection-oriented. Next Generation telecommunication networks will be quite the opposite—distributed, loosely coupled, open, packet-based, and data-centric. Wireline and wireless networks will converge—with a common core network, communication via Internet Protocol (“IP”) as the common language. Next Generation Networks (NGNs) will be expected to meet and exceed current performance attributes—the performance of IP flow through packet networks. This is termed as an IP Quality of Service (QoS). An IP QoS is required to provide a consistent performance and behavior for user traffic. Each customer has different traffic requirements depending upon their business model and therefore, cannot be globally fixed to single performance level. However, certain traffic such as voice and video, require special treatment to be acceptable regardless of their priority with respect to all other user traffic.

QoS is measured as a set of parameters—delay, throughput, packet loss and jitter. Depending upon the traffic carried by the network (time sensitive financial transactions, large data files, voice, video, etc.), each or all of these parameters become critical in defining network performance. For example, the data rate needed for voice communication is unacceptable when transmitting high-resolution data images; likewise, network delays in transferring large files are intolerable for real-time voice traffic. When implementing QoS, emphasis must be on the specific characteristics of the traffic model.

The need for IP QoS is being driven by new applications such as eCommerce, IP telephony and the proliferation of streaming audio and video Web content. Because there is currently no QoS over the Internet, voice and video applications have to rely on highly compressed media and increased amounts of bandwidth to achieve an acceptable quality that is not consistently achieved.

In private enterprise networks, IP QoS can be engineered through labor-intensive router filter configuration. However, this is problematic because it often is not applied consistently across the enterprise network resulting in inconsistent performance. Policy-enabled networking is the first step in achieving IP QoS.

In the campus, IP traffic over LANs can achieve QoS using simple traffic management mechanisms without complex bandwidth reservation schemes. This can be achieved because bandwidth is high (10-100 Mbps) and is rapidly moving towards a switched environment with 10-100 Mbps dedicated to each user. Over the WAN, bandwidth is less plentiful and bandwidth reservation mechanisms will still be needed in the short term.

The WAN bottleneck is predominantly at the last mile connecting the enterprise to the backbone network. However, with new high-bandwidth access technologies such as XDSL (Digital Subscriber Line) and DWDM (Dense Wave Division Multiplexing) being rapidly deployed, this bandwidth bottleneck will decrease. Consequently, the need for complex bandwidth reservation mechanisms for the WAN will not be needed in these situations and simple prioritization and congestion management mechanisms can be deployed to achieve end-to-end QoS. However, in the wireless environment, problems remain due to low-bandwidth access.

Such requirements led to a separation of the network. The logical separation of network takes place for the access service provider, network (core) service provider, application/service application provider and infrastructure (transport) service provider. These network resources are not unlimited. Therefore, network resources must account for traffic flows entering a network. Hence, a definite need for accounting management architecture has arisen that provides a scheme and procedure to record network usages for monitoring and billing purposes. Moreover, multiple service providers may need different accounting schemes. Alternatively, each provider must be flexible in providing multiple services. Thus, an accounting management of the proposed network should be flexible to capture various metrics of usage from which each service provider can extract their billing strategies. Moreover, accounting management needs to capture accounting usage data to be based on the QoS provided as specific resources are configured to achieve the desired QoS.

### SUMMARY OF THE INVENTION

The present invention is related to the patent applications entitled “An architecture for an IP centric distributed network” (filed on Nov. 5, 1999, Ser. No. 09/434,628, Docket No. 22171.121), “A system and method for service session management in an IP centric distributed network” (filed on Jul. 24,2000, Ser. No. 09/624,066, Docket No. 22172.223), and “A system and method for Accounting Management In an IP centric distributed network”, (filed on Nov. 7, 2000 Ser. No. 09/707,522, Docket number 22171.252. These patent applications describe the next generation network (NGN) architecture centered on IP mobility, call/session management, network management services, service session management activities, and basic accounting management activities. Collectively, these patents provide a network architecture baseline and identify network services.

An accounting management service is a network service, based on the QoS provided, that coordinates system components that monitor and record network resources used. Accounting management enforces, based on the QoS provided, the accounting and billing policies for services. Collection and reporting, for each QoS configuration provided to the end user, of the charging data to the operator's billing system is also done by the accounting management service. The accounting management architectural components, their positioning and responsibilities within an IP-centric distributed network, are discussed in a referenced patent application, Ser. No. 09/707,522. The interactions between the components use standard protocols. The configurations of accounting management activities are primarily distributed in various session establishment tasks. The session establishment tasks include access, service and transport session establishment. An accounting client can be at an allied application server, at the access network, or possibly at the end device. Such accounting clients facilitate the accounting activities at the service level for the end users. The accounting server and policy manager (alternatively, the authorization server) components of the core network, in coordination with the accounting clients (e.g. at an access network), and the connection manager facilitate various accounting needs for network resources usage, for the QoS provided. The accounting server interfaces with the storage disk to protect and store collected accounting data. The billing server interfaces with such devices to fetch collected data in order to create customer billable records.

The present invention describes an accounting management support that accommodates desired accounting parameters based on the QoS requested. Also, it accommodates modifying accounting parameters based on a dynamic change in the QoS requested during an active session. Thus, the present invention supports accounting management activities for multiple simultaneous applications or services based on their assigned QoS. The present invention dynamically segments and aligns the billing along the lines of the dynamic QoS modification. This feature is an advantage to the operator and allows for full compensation of network resource use.

Therefore, in accordance with the previous summary, objects, features and advantages of the present invention will become apparent to one skilled in the art from the subsequent description and the appended claims taken in conjunction with the accompanying drawings.

### BRIEF DESCRIPTION OF DRAWINGS

FIG. 1: NGN Accounting Management Architecture Model Abstract level;

FIG. 2: Network view Abstract Level;

FIG. 3: Overview of an access scenario Explicit request at the Access Network;

FIG. 4: Explicit QoS change request at the Core Network by MH upon service session invocation;

FIG. 5: Explicit QoS change request at the Core Network by MH upon receiving explicit request for change in QoS;

FIG. 6: Access Session Accounting for Registration;

FIG. 7: Access Session Accounting for Deregistration; and

FIG. 8: Implicit request to change QoS through allied application server.

### DETAILED DESCRIPTION OF THE PREFERRED EMBODIMENTS

The present invention can be described with several examples illustrated in figures and scenarios provided through out this document. It is understood, however, that the examples are not necessarily limitations to the present invention, but are used to describe typical embodiments of operation. Moreover, in order to simplify discussion, certain protocols such as DIAMETER, LDAP, COPS, SIP, RSVP, MPLS, etc. are used as an example where appropriate. In fact, the NGN accounting management architecture is flexible to adopt any publicly available protocols for the similar functions. For example, other alternative protocols for DIAMETER include RADIUS, TACACS or it's extensions, etc. An appropriate procedure may require specific client server applications for the relevant protocol. Also, at instances Radio Access Network is illustrated for simplicity for the access network. However, the NGN accounting management architecture is access network agnostic. Additionally, a list of abbreviations and glossary will be listed first to facilitate a better understanding of the invention.

Abbreviations

| | |
|---|---|
| AAA | Authorization Authentication Accounting |
| AAA+ | Authentication, Authorization, and Accounting |
| | extension |
| ASP | Application Service Provider |
| AMI | Accounting Model Indicator |
| API | Application Protocol Interface |
| dB | data Base |
| DEN | Directory Enabled Networking |
| DiffServ | Differentiated Services Architecture |
| DS | Directory Server |
| DSCP | DS Code Point |
| DS Field | DiffServ Field |
| DWDM | Dense Wave Division Multiplexing |
| IntServ | Integrated Services Architecture |
| IP | Internet Protocol |
| IPv4 | Internet Protocol version 4 |
| IPv6 | Internet Protocol version 6 |
| LAN | Local Area Network |
| LDAP | Lightweight Directory Access Protocol |
| LDP | Local Decision Point |
| LSF | Local Serving Function |
| MH | Mobile Host |
| MM | Mobility Manager |
| MPLS | Multiprotocol Labeling System |
| MS | Mobile Station |
| NSF | Network Serving Function |
| NGN | Next Generation Network |
| PEP | Policy Enforcement Point |
| PDP | Policy Decision Point |
| QoS | QoS |
| RADIUS | Remote Authentication Dial In User Service |
| RAN | Radio Access Network |
| SA | Security Association |
| SAE | Service Accounting Entry |
| SDR | Session Detail Record |
| SLA | Service Level Agreement |
| SM | Session Management (role or function) |
| SSM | Service Session Management |
| TACAS | Telnet ACcess Access Control System-protocol |
| | used for Telnet access authentication |
| xDSL | x = A, S (asynchronous, synchronous) Digital |
| | Subscriber Line |
| xAN | Any Access Network |
| UD | Unified Directory |
| UAE | Usage Accounting Entry |
| VoIP | Voice over Internet Protocol |
| WAN | Wide Area Network |

Definition of Terms

Next Generation Network (NGN):

The NGN is the IP centric core-network consisting of LSF and NSF network components. The NGN is assumed to be independent of air interface technology. The interfaces between system components of the NGN are based on the LAN/WAN technology and uses a client server architecture. The unified network and the next generation network terms used interchangeably in this document.

Access Session:

A specific type of session established between a Mobile Host (MH) and the Radio Access Network (RAN) when the MH powers on and registers to the LSF. A link is established from the mobile host to the connection management component within the RAN. Once the access session is established, the mobile host becomes an IP capable host that can reach or be reached by any other device. The access session remains active at all times as long as the mobile host remains attached to the serving network.

Accounting:

The act of collecting information on resource usage for the exemplary purposes of trend analysis, auditing, billing, or cost allocation.

Accounting Client:

The Accounting Client collects resource consumption data in the form of accounting data. This information is then transferred to an accounting server located at the LSF using an accounting protocol (e.g. DIAMETER). The Accounting Clients can reside at the access network (e.g. RAN), and the allied application servers that provides services in association with the core network components or at third party application servers in the Internet.

Accounting Model Indicator (AMI):

The AMI is a specific field within the accounting policy stored in the policy server. It is passed as a field within the user's profile to an accounting client to define the method and timeliness of data collection (e.g. batch, poll, or real-time transfer).

Accounting Server:

The accounting server receives accounting data from Accounting Clients via an accounting protocol (e.g. DIAMETER). The Accounting Server provides summarization, correlation of the accounting records, and translates them into session detail records (SDRs). The accounting server in the LSF routes the session detail records to the accounting server in the NSF for persistent storage.

Accounting Session:

For any session (Service Session or Access Session), an Accounting Session is created at the Accounting Server in the LSF. A session may generate one or more Accounting Sessions due to handoff/roaming. The Accounting Sessions are initiated by the Accounting Clients by sending an accounting Start Record to the Accounting Server. A Session Detail Record (SDR) is allocated for each accounting session and is updated as the session progresses. The Accounting Server holds and maintains the state of the Accounting Session. The termination of an Accounting Session occurs when a Stop_Record is received from an Accounting Client.

Accounting Session ID:

Each Accounting Session has a unique Accounting Session ID, which is different from a session ID. If a single session requires multiple SDRs, the Accounting Session ID is the same across the multiple SDRs.

Application Server:

An application server provides services to the end user.

Allied Application Server:

An allied application server provides services to the end user in association with the core network of the serving service provider. An allied application server uses the serving service provider's network resources in facilitating value added services to the end user. For example, an application server that provides protocol services can use certain session management functions provided by the core network components to facilitate a change of bandwidth, QoS, or a change in QoS, etc . . . .

Third Party Application Server:

The third party application server provides services to the end user independent from the core network components of the network service provider. In this case, for example, the third party application server is limited to provide any service to the end user to the default bandwidth or QoS provided during access session establishment.

Authentication:

The act of verifying the identity of an entity (mobile host user).

Authorization:

The act of determining whether a requesting entity (mobile host user) will be allowed access to a resource or service.

Billing Server:

A server typically residing outside the service provider network. The server is in charge of collecting the accounting data from multiple networks, performing any final record correlation, and generating the billing invoices for subscribers.

Core Network:

The core network indicates the network specific functional components that can provide the decision-making capabilities in order to provide services to the end users, application service platforms, and to other networks. The core network can be hierarchically divided into sub layers as needed based on the network scope and coverage. Commonly the core network is divided into two service layers; a local service layer and network service layer. Additionally, the core network is access agnostic.

Directory Server (DS):

The DS provides interfaces to the Unified Directory (databases). The DS services give structure to complex and heterogeneous networks by enabling the tools that provide access to, and management of networks. The client of the directory server access the information contained in these databases via a standard access protocol such as DAP or LDAP. The database schema, the type of database and storage techniques is transparent to the clients. The directory server receives the queries from the clients and retrieves the information from the databases. The interface between the directory server and the databases may be proprietary or standard based. The directory server formats the information retrieved from the database and sends it back to the client in the appropriate response message.

Interim_Record:

An Interim_Record contains cumulative accounting information for the duration of one interval only. The selection of whether to use Interim_Record is directed by the DIAMETER Accounting_Interim_Interval attribute.

Local Service Function (LSF):

The LSF is the serving area network for sets of access networks. It is owned by the operator and separated by the geographical parameters. It consists of several system components. Some of these components are call servers, mobility manager, directory server, DHCP, DNS, Gateway devices, etc. The LSF is the serving component of the UN that provides services to local and visiting subscriber (users) in that area.

Local Service Layer:

The local service layer is part of the core network. It externally interfaces towards an access network and the service application servers. It facilitates the ingress and egress activities relevant to the end users. Also, internally, it interfaces with the network service layer that provides global network functions.

Network Service Layer:

The network service layer is part of the core network. It externally interfaces towards other global networks, and application servers. It facilitates the information bridging between different networks. Also, internally, it interfaces with the local service layer to exchange relevant information.

Network Services:

The network services are the services that are provided by the core network components. The core network components are hierarchically distributed in local service layer and network service layer. The network service functions are the functions provided by the network service layer functional components. And, the local service functions are the functions provided by the local service layer functional components. The network services include the accounting management functions.

Network Serving Function (NSF):

The NSF is the home network that owns the subscription associated with the end user. It is a user subscription defined entity. It consists of several system components. These components may include legacy components through the necessary interfaces or their functional equivalent suitable to the IP centric environment. Some of these components are HLR, SCP, Unified Directory, AAA server, SN, IP Application Service Platform (provides value added applications to the client), etc. Network Serving Function (NSF) is the global home component of the UN that owns the end user's subscription.

Radio Access Network (RAN):

The RAN is the system component of the wireless network that provides the radio control functions used in transmitting and receiving control and data information between mobiles and the core network. The RAN itself is air technology dependent. However, it is evolving to provide independent functionality towards the IP centric core network. On this basis, the RAN is assumed to have distinct radio interface and radio management components. Thus, radio management components provide the radio independent functionality towards the IP centric core network. Although RAN is used as an example throughout the text, xAN is also represents any access technology and is used interchangably.

Service Accounting Entry (SAE):

The SAE is a buffer at the Core network allied application server containing accounting data relevant to a specific service invocation.

Service Session:

A specific type of session established between an end user and the LSF when the end user invokes an LSF-provided service. A link is established from the mobile host to the application server component within the LSF. Once the service session is established, the LSF components coordinate in providing the requested service. The service session remains active until the user or terminating device explicitly halts it.

Session Detail Record (SDR):

A SDR is a record containing the accounting information for a complete session. The LSF Accounting Server creates an SDR when an accounting session is initiated. While maintaining the accounting session state, the LSF Accounting Server updates the SDR when it receives an Interim_Record from an Accounting Client. Upon session termination, the LSF accounting server updates the SDR and sends it to the NSF Accounting Server.

Start_Record:

A Start_Record is used to indicate a new accounting session, and contains accounting information that is relevant to the initiation of the session.

Stop_Record:

A Stop_Record is used to terminate an accounting session and contains cumulative accounting information relevant to the terminated session.

Transport Session:

In a Transport Session, network resources are allocated and reserved for transport of bearer path data. A virtual packet channel path is setup and payload coding/decoding begins. Both Access Session and Service Session have associated Transport Sessions in the air interface and in the xAN. In the air interface the transport session includes layer 2 connectivity between the end user and the xAN.

Usage Accounting Entry (UAE):

A UAE is a buffer at the xAN containing accounting data relevant to usage.

Unified Director (UD):

A UD is a database in which various types of information associated with the network is stored. This information includes the objects in the network infrastructure that consists of user profile, server locations, applications, hubs, routers, policy rules, service level agreements, etc. For example, directories that are commonly used are based on X.500, which is an ITU standard for directories in the telecommunications space.

Any Access Network (xAN):

The core network is access technology agnostic; access networks can be any type of access technology. Thus, xAN indicates the access network attached to the core network can be a wireless access supporting any air technology, wire-line access, LAN based network or any other kind of access network. For simplicity and ease of understanding, at various places in this document radio access network (RAN) is used for an example.

Connection Manager:

The Connection Manager entity is the part of an access network support in the NGN architecture. It can be addressed using an IP address. Thus, any components, for example, from access network or core network, can interface with the Connection Manager entity. Basically, this entity provides routing functions such as an access gateway or a router. With respect to the accounting architecture, this entity collects usage data and reports to an accounting client application that is associated at the access network. The Connection Manager can receive IP level messages and provide policy enforcement functions for the data transmitted through it. Based on the policy decision provided, or through another mechanism, it can enforce data collection function as requested.

Overview of an NGN Accounting Management Model

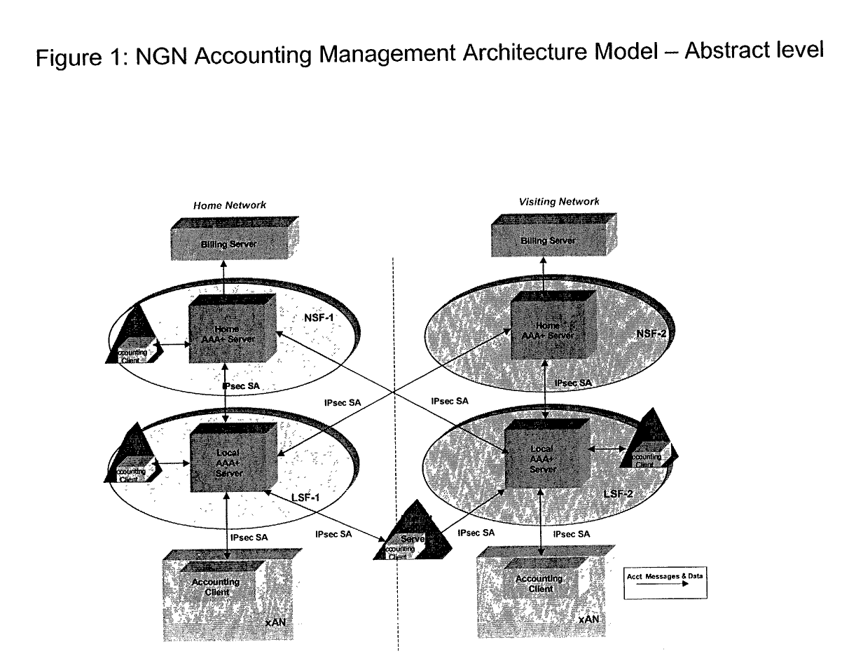

The description provided here is based on incorporated by reference patent application Ser. No. 09/707,522. FIG. 1 illustrates an NGN accounting management architectural model. It depicts major system components and interfaces. The accounting management activities are integrated with the session management activities. The session management activities include establishment of an access session, service session, and transport session. Thus, the accounting management aspect is distributed within these sessions' establishment task. Major session management functions include feature analysis, enforcement of network preferences and user capabilities, dynamic provisioning of QoS, dynamic provisioning of data rates, enforcing access restriction at the serving network, routing functions, connection types, handling of multi-media sessions, and accounting, etc.

The accounting management functional role is collectively provided, coordinated and performed by the core network functional components, the core network allied service application servers and the access network functional components. In order to optimize performance, these functions are distributed in different service layers and information is cached to an appropriate local decision point. Such a local decision point in the hierarchy has the capability to provide decision enforcement.

The Accounting Clients can reside anywhere on the network, possibly at the xAN, at an allied application server platform, at the core network, at the end device and even on an Internet third party application server platform. The Accounting Servers can reside at the core network. The network service layer and the local service layer can have separate accounting servers based on the hierarchy and distributed control functions established by the service provider. The Accounting Server also may reside at the xAN in cases where the xAN is operated and owned by a different operator other than the LSF operator.

An activation of an accounting client takes place in several cases, such as, at mobile host registration time and/or at service invocation time. The NGN core network's (LSF [symbol] NSF) session management functions inform the Accounting Clients of the method of data transfer based on stored policies. The LSF components establishes an appropriate link with the NSF components if the network has established an NSF/LSF hierarchy. This data transfer method is either real-time (immediately), batch (store and forward later), or on a poll (send only upon request) basis.

The allied application server in association with the core network's session management functions provides the invocation of a service session. The SAE is instantiated at the allied application server upon service invocation. The SAE initiates SDR at the accounting server. Similarly, the service session management function initiates UAE at the xAN. The service session invocation and termination will be accounted for in the NGN LSF via the SAE of an allied application server. The service session begins when the service is invoked and ends when the service is terminated.

General Overview

The present invention provides the system and method to support accounting management activities for multiple simultaneous applications or services based on their assigned QoS. During static configuration, a default QoS is configured for each service, based on end user information. Dynamic configuration for the required QoS is performed upon service invocation. Moreover, an end user may request a change in QoS during the service session to accommodate a temporary need of a different QoS. The end user also may request a change in QoS implicitly through service invocation to the allied application servers or explicitly to the network components directly. In any case, based on the subscribers' policy and network's preferences and policy, the QoS is configured. An accounting management activity that facilitates to capture such usage, with respect to the provided QoS, is described in the text below. The configuration of accounting management activities is primarily distributed within session establishment tasks. The session establishment task includes access, service and transport session establishment.

The mechanism to initiate and collect interim usage data, and stop functions associated with the accounting management are illustrated in the incorporated by reference patent application Ser. No. 09/707,522. This mechanism allows to instantiate multiple UAEs and SAEs during service session—based on desired QoS. Such UAEs and SAEs capture associated accounting usage data based on the QoS provided. The remainder of the text explains how and which QoS metrics for usage are considered, by using exemplary scenarios.

The NGN Architecture and QoS

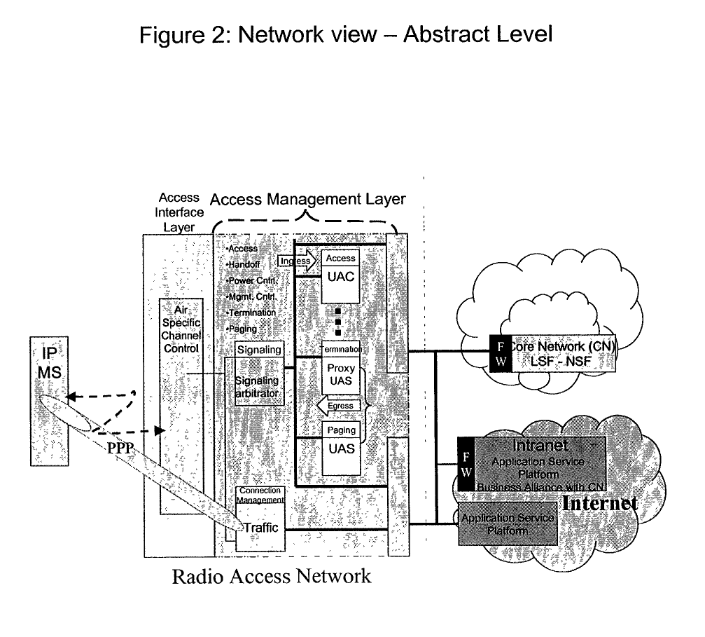

This section describes the accounting management activities with respect to QoS. First, an abstract view of the NGN architecture is provided in FIG. 2: Network view Abstract Level. Second, objectives are identified with respect to the QoS. Then, vulnerable points within the network that degrades QoS are identified. Finally, QoS techniques applied to the NGN architecture that minimizes QoS degradation are illustrated.

Network View—Abstract Level, Objectives with Respect to the QoS

The call/session management tasks are expected to achieve objectives for three basic functions. These functions are comprised of: first establishing, maintaining and terminating an access session between mobile host and the serving network; second, providing network services to the mobile host that allows mobile host to establish a service session; and third, facilitating transport resources of the serving network to establish transport session based on the mobile hosts' need of bandwidth with desired QoS. The desired objectives with respect to the QoS for these three functions are elaborated in this section. Moreover, as the call/session management functions are real time sensitive in which access of decision-making information and propagation delay through the network infrastructure plays an important and critical role. The real time and other similar issues lead to vulnerability in achieving desired QoS.

Access Related Objectives

An establishment of an access session enables the mobile host to establish a point of presence at the local serving network. During access session establishment, subscriber management services are executed. These services include admitting policy control decision, provisioning of default air link resources, and establishing the virtual packet channel that allows mobile hosts to interface with the external Internet network. The following objectives are identified to achieve:

provisioning the local serving functions with access and usage profile in order to provide allowed access and usage services to the mobile host;

handling of flexible bandwidth provisioning and supporting requirements;

handling of accounting requirements based on flat rate, per packet, time used, and/or QoS provided;

handling of incremental data speed requirements of up to 144 kb/s for vehicular user, up to 384 kb/s for outdoor to indoor mobility, and up to 2 Mb/s for indoors and Pico cells environments; and

handling of QoS requirement based on the end users, need and network's capabilities and preferences.

Service Session Related Objectives

The service session enables an end user to use services provided by the serving network. Also, an end user can use the serving network services to dynamically change network transport resources. That will allow an end user to globally access available network services at needed bandwidth and at a desired QoS. The following are few identified objectives:

identify scheme for reporting network resource usage for each type of service within the same service session; and

service capabilities related to information and functionality such as dynamic negotiation of QoS, use of Intranet service and use of communication resources.

Transport Related Objectives

The transport session activities enable the mobile host to use the network's air and virtual packet channel path resources. The following are few identified objectives:

establishing bearer connection path for an air link and virtual packet channel towards network infrastructure using serving network's resources;

facilitating Point to Point, Point to Multi-point and Multi-point to multi-point connection;

facilitating use of underlying network infrastructure resources such as MPLS, DiffServ, IntServ, ATM, FR, or Ethernet; and

facilitating network resources appropriately that achieves desired data rates and quality of service.

Performance Objectives

The following includes a few other objectives:

minimum packet delay; ITU recommends round-trip delay less than 300 ms;

minimum packet loss, such that no noticeable degrade in voice quality and the performance of fax;

maximum throughput via a virtual connection; and

optimized bandwidth distribution.

Overview of Access Scenarios That Request Change of QoS

It is important to note that the communication path between two end devices establishes virtual connections as bearer data transits in packets. Moreover, when wireless device is involved in communication, then communication involves different transport mediums, such as air and terrestrial. Thus, at the intersections where such separate medium meet, communication becomes vulnerable with respect to quality.

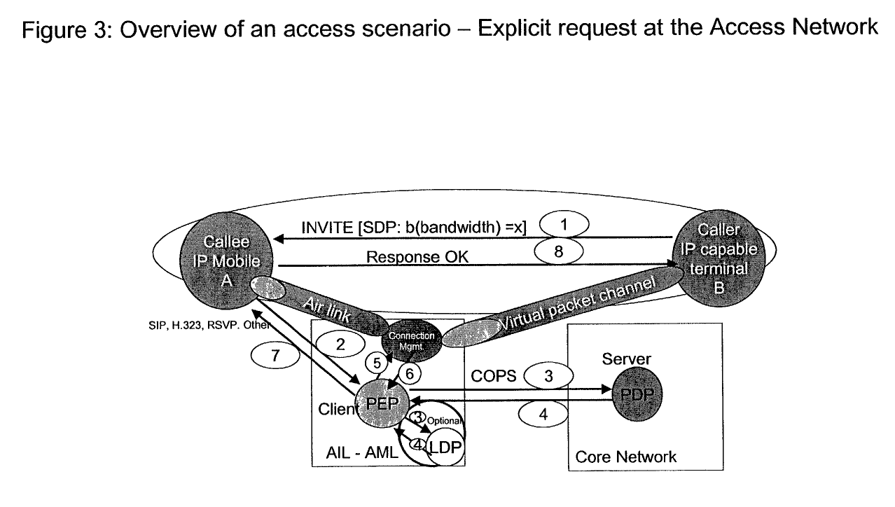

Two paths are illustrated in FIG. 3. The access point is involved during the session control phase. First A, facilitates to control air and virtual packet channel path. Second B, facilitates signaling interactions with core network to establish session and allocation of local resources.

A: Control of Air and Virtual Packet Channel Path

The FIG. 3: Overview of an access scenario shows two distinct channels through which traffic data flows as follows: one through the air link and another through the virtual packet channel.

The virtual packet channel can be established through all the routers along the data path-using RSVP (e.g. IntServ or DiffServ network configuration). Thus, the control of the virtual link and dynamic bandwidth changes can be obtained by using RSVP processed at each router along the data path. However, the control of the air link is not trivial. This is because of two reasons. First, the data transformation at the connection management does not distinguish data from signaling and thus, does not process the signaling protocol. Signaling information is merely transported through the wireless access point to the end terminal. Thus, it becomes the end terminal's responsibility to interact with the access point to allocate or modify the bandwidth necessary for the air path. This leads to the second point where bandwidth adjustment requires a unique signaling handshake between the IP Mobile host and the access point (AIL-AML interface).

B: Control of Session Establishment and Resource Allocation

Within the wireless access point, the client agent for the end user performs several functions. Some of these functions include interactions with the core network. In context of the quality of service authorization and appropriate resource allocation, the user agent at the access point (client or server) performs the role of policy enforcement while the core network performs the role of making policy decisions. Depending on the implementation choice, interactions related to the policy can be performed locally at an access point or at the core network. It is practical to distribute default parameters and the subscribers' allowed resource allocation at the time of registration to the local domain database (at access point). In this case the policy enforcement function that is a part of the user agent (e.g. access management server), performs decisions based on the local decision point (LDP).

Other Scenarios

Although, IP capable end terminals can communicate with each other transparently, wireless access points play an important role in establishing the air link path. At the same time, it is also important to establish an appropriate infrastructure (e.g. using DiffServ, IntServ, MPLS, ATM etc.) that provides a terrestrial path that establishes virtual channel with the desired quality of service. In order to perform this task, an access point can get directives from the end user, from the core network, or directly from the other end device or network if an independent access point is capable to terminate appropriate signaling.

An intervention at the wireless access point can occur several times during the communication. There are many combinations that can be graphically illustrated. However, only few are shown in FIGS. 3, 4 and 5. However, the end terminal can use the appropriate protocols to request a change in quality of service to an access point or to the core network components. If the access point is allied with the core network then, the handshake between the access point and the core network will determine admission control. Several example scenarios in the following text.

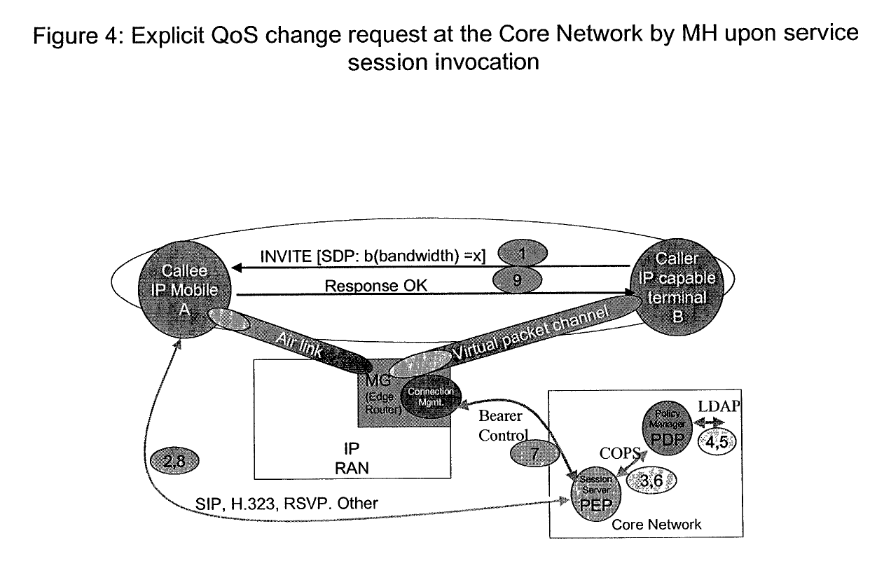

Assume end terminals are communicating in active state and the wireless access side terminal demands a QoS adjustment request to access the system. FIG. 4 shows an explicit QoS change request at the Core Network by MH upon service session invocation. Also, note that it is possible that the end terminal may request a change in QoS to the access point rather than to the core network.

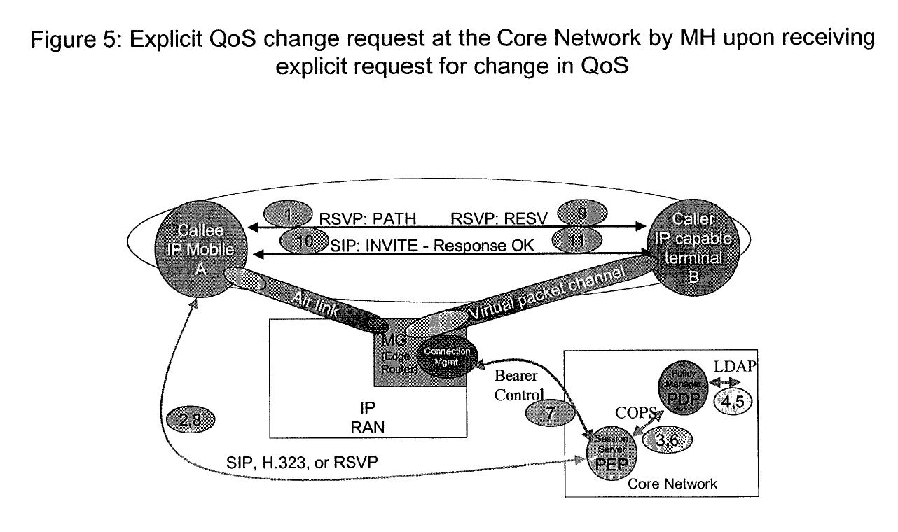

A scenario during call/session termination is shown in FIG. 5. While the mobile host is in an attached and dormant state, an external caller requests to setup desired QoS and in response the end terminal demands QoS different than the default assignment. This scenario illustrates an explicit QoS change request at the Core Network by the MH upon receiving an explicit request for change in QoS illustrates this scenario. Also, note that it is possible that the end terminal may request a change in QoS to the access point rather than to the core network.

Another scenario is when the wireless mobile host seeks a value added service invocation through the help of access system. This scenario is not shown. Such invocation illustrates when a proxy for the end terminal is present at the access point.

During the mobile host attachment to the wireless access system (power up case), the default QoS is used.

Techniques That Networks Can Use to achieve Desired QoS

QoS is measured as a set of parameters: delay, throughput, packet loss and jitter. Depending upon the traffic carried by the network (time sensitive financial transactions, large data files, voice, video, etc.), each or all of these parameters become critical in defining network performance. For example, the data rate needed for voice communication is unacceptable when transmitting high-resolution data images; likewise, network delays in transferring large files are intolerable for real-time voice traffic. When implementing QoS, emphasis must be on the specific characteristics of the traffic model. QoS is implemented primarily based on two architectures among many available schemes: DiffServ (Differentiated Services Architecture) and IntServ (Integrated Services Architecture). Regardless of which techniques are used to configure the network, the NGN's accounting management scheme is flexible enough to adopt and capture the usage set based on the configured QoS.

DiffServ Architecture

This architecture is composed of a number of functional elements implemented in network nodes, including a small set of per-hop forwarding behaviors, packet classification functions, and traffic conditioning functions including metering, marking, shaping, and policing. This architecture achieves scalability by implementing complex classification and conditioning functions only at network Boundary Nodes, and by applying per-hop behaviors to aggregates of traffic, which have been appropriately, marked using the DS Field in the IPv4 header or Traffic Class octet in the IPv6 header. Per-hop behaviors are defined to permit a reasonably granular means of allocating buffer and bandwidth resources at each node among competing traffic streams. Per-application flow or per-customer forwarding state need not be maintained within the core of the network.

The differentiated services architecture is based on a simple model where traffic entering a network is classified and possibly conditioned at the boundaries of the network, and assigned to different behavior aggregates. A single DS Code Point (DSCP) identifies each behavior aggregate. Within the core of the network, packets are forwarded according to the per-hop behavior associated with the DS Code Point. The type of packet marking dictates the forwarding treatment given to the packet at each hop. The packet marking is based on network policies that are pushed down by the policy manager based upon the type of service required. Marked packets receive specific per-hop, forwarding treatment by each router throughout the DiffServ compliant network. The per-hop treatment depends upon the service class level based upon how the devices treat a given DSCP.

IntServ Architecture

IntServ uses RSVP (Resource Reservation Protocol) as a signaling protocol. RSVP is used to signal whether resources are available at every hop in the path of the packet (based on the traffic class assigned to it). Because a per-flow soft state is necessarily maintained, and because a “resv” message is sent every time to signal the start of packet transmission at the source (when a complete path is guaranteed), IntServ does not scale well and may waste network resources. The IntServ architecture, uses RSVP as the admission control mechanism to achieve QoS. The scalability limitations of IntServ have also limited its deployment.

MPLS Architecture

Multi Protocol Label Switching (MPLS) is a forwarding scheme, based on the OSI model, between layer 2 (link layer) and layer 3 (network layer). MPLS packet headers are encapsulated between the link layer header and the network layer header. MPLS-capable routers (called LSRs-label switched routers), examines this label to forward the packet. Any network protocol (IP included) can be used for this, hence the term multiprotocol label switching. MPLS requires a protocol to distribute labels to set up label switched paths (LSPs); this protocol is either RSVP or a generic label distribution protocol (LDP). MPLS and DiffServ can be used together to implement QoS in service architecture. MPLS provides a fixed length label to decide packet handling and is a useful tool for traffic engineering.

QoS implementations today tend to favor DiffServ supplemented with some RSVP capabilities.

For QoS to be successful, agreements should be in place between different networks (resource reservation, guaranteed delivery, packet loss, jitter, delay, etc.) and between providers and their customers. Termed as Service Level Agreements (SLAs), it means that if a customer is paying for a packet loss of 1%, then the service provider must have contractual agreements in place to ensure this level of service. It is in the interests of all service providers to ensure this across multiple networks. SLAs are typically end-to-end service specifications and may consist of—availability (guaranteed uptime), services offered (specification of service levels offered), service guarantees (for each class—packet loss, delay throughput, jitter), responsibilities (consequences for breaking contract rules), service auditing, and pricing. SLAs are negotiated between service providers and their customers, or between service providers of different networks.

Categories of QoS That an End User Can Request

The criteria illustrated in this section is an example an end user could use when requesting desired QoS. Based on the QoS request, the NGN architecture configures network resources to achieve the desired QoS. The NGN architecture uses appropriate network configuration such as MPLS techniques, DiffServ Architecture technique, IntServ techniques, ATM network configuration, or similar others to match and achieve the desired QoS requested. The NGN accounting management architecture establishes appropriate User Agent Entities (UAEs) at the access network and the Service Agent Entities (SAEs) at the allied application servers that facilitate to capture usage data for each category assigned by the network for a specific QoS.

| IP Service Class | Traffic Categories | Examples |
|---|---|---|
| Critical | Network Control | Alarms, heartbeats |
| Network | ″ | Routing table |
| | | updates |
| Premium | Real-time, delay | VoIP |
| | intolerant | |
| Platinum | Real-time, delay | Streaming Video |
| Gold | tolerant | Audio, video on |
| | ″ | demand |
| Silver | Non real-time, | Transaction |
| | mission-critical | processing |
| | non-interactive | |
| Bronze | Non real-time, | Email |
| | mission-critical | |
| | non-interactive | |
| Standard | Non real-time, non | FTP (best effort) |
| | mission critical | |
| Custom | ″ | Broadcast |
| | | (continuous |
| | | delivery) |

As an example, from the table above, a user requests a Premium service—based on the requirement to make a VoIP call. The network ensures, with the SLAs in place, that enough bandwidth and buffering are provisioned to make this VOIP call. The network will also determine the optimal implementation methods to use, such as MPLS, IntServ, DiffServ, DiffServ with RSVP, or any other available techniques. Accounting agents are informed to collect relevant usage data accordingly through the appropriate UAEs and SAEs, based on the requirements. Should the resources not be adequate to complete this call, the network, based on the QoS provided, will make arrangements to route the call via other nodes where bandwidth/buffering are not scarce. Additional provisioning, based on possible QoS changes during the call, will also have to be statistically accounted for. Likewise, Critical, Network and other service classes will cause network infrastructure to be provisioned by the network accordingly.

QoS Relevant Accounting Events and Actions

The following table shows QoS relevant events that cause actions to be taken within the NGN accounting architecture:

| Events | Accounting Actions |
|---|---|
| QoS update | UAE corresponding to the requested QoS is |
| request from | created at the xAN indicating allocated |
| the attached | resources |
| end device | Accounting Model Indicator sent to xAN |
| (e.g. explicit | START_Record sent from xAN to LSF Accounting |
| request using | Server |
| RSVP) | SDR is updated for corresponding QoS UAE at LSF |
| Access point | Accounting Server |
| interacts with | |
| the policy | |
| manager (PM) | |
| PM can be at | |
| the access | |
| point or at the | |
| core network | |
| QoS update | UAE corresponding to the requested QoS is |
| request from | created at the xAN indicating allocated |
| remote end | resources (subscriber's profile shall allow such |
| device or | request to change QoS) |
| network (e.g. | Accounting Model Indicator sent to xAN |
| explicit | START_Record sent from xAN to LSF ccounting |
| request using | Server |
| RSVP) | SDR is updated for corresponding QoS UAE at LSF |
| Access point | Accounting Server |
| interacts with | |
| the policy | |
| manager (PM) | |
| PM can be at | |
| the access | |
| point or at the | |
| core network | |
| QoS update | SAE created at Core network allied application |
| request from | server indicating allocated resources |
| the Allied | START_Record sent from Core network allied |
| application | application server to LSF Accounting Server |
| server | SDR is updated for corresponding QoS UAE at LSF |
| (possibly | Accounting Server |
| facilitated | Accounting Model Indicator sent to xAN |
| through the | Service session UAE created at the xAN to track |
| Core Network | usage specific to this change of QoS request |
| e.g. Implicit | |
| request using | |
| SIP to the | |
| allied | |
| application | |
| server) | |
| QoS update | STOP_Record with original QoS usage data from |
| during service | UAE sent to LSF Accounting Server |
| session | Old service session UAE de-allocated at the xAN |
| | SDR updated at LSF Accounting Server (to be de- |
| | allocated at a later time) |
| | SDR sent from LSF Accounting Server to user's |
| | home NSF Accounting Server * |
| | SDR stored at user's home NSF Accounting Server |
| | New service session UAE created at the xAN to |
| | track usage specific to this new QoS session |
| | START Record for new QoS session sent from xAN |
| | to LSF Accounting Server |
| | SDR created at LSF Accounting Server with same |
| | Accounting Session ID |
| QoS update | UAE created at the xAN to track usage specific |
| while the end- | to this new QoS session |
| user is an | START_Record for new QoS session sent from xAN |
| Internet | to LSF Accounting Server |
| application | SDR is updated for the created UAE at LSF |
| server session | Accounting Server with same Accounting Session |
| | ID |

This section provides several example scenarios in reference to QoS and change in QoS that describe the accounting management activities that take place within the NGN architecture. These scenarios are grouped in three parts; covering Default setting of QoS, Implicit request to change QoS, and Explicit request to change QoS. Please note that a Radio Access Network is used in some instances as an example that represents the access network.

Default Setting of QoS During Access Session Establishment

The following two scenarios illustrate a basic setting of accounting parameters during access session establishment using default QoS based on the subscription and the network capabilities and preferences.

Access Session Accounting for Registration

This scenario demonstrates the accounting activities on MH registration. The two main activities shown are the establishment of the Accounting Model Indicator within the xAN and the sending of the START_Record to the LSF Accounting Server. As described in referenced patent application Ser. No. 09/707,522, the Accounting Model Indicator defines the collection model for accounting data (polling, event-driven polling, event-driven without batching, or event-driven with batching).

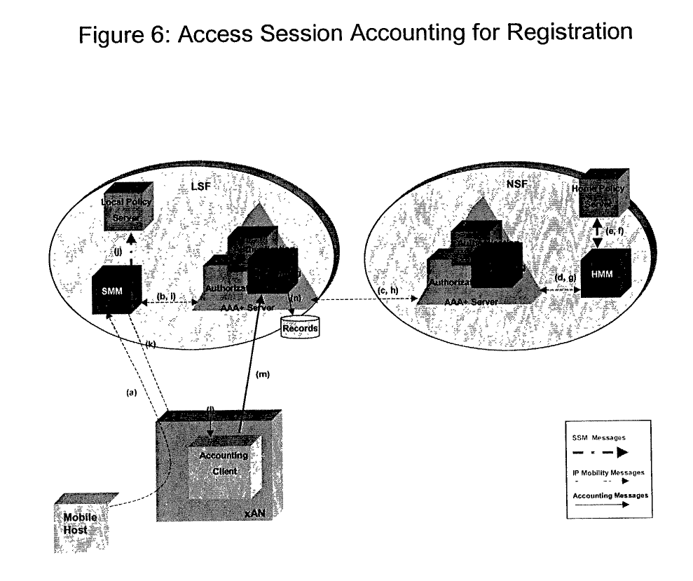

FIG. 6 illustrates access session accounting for registration describes each step that takes place during this process.

a-k) The initial system access procedure including Authentication, Registration and policy download, is performed.

l) The Registration Reply message received by the xAN in step (k) includes the policy and Accounting Model Indicator. When the IP session between the MH and xAN is established using the granted QoS and bandwidth, the access session established event is sent by the xAN Connection Manager to the Accounting Client. Included in the access session established event is the Accounting Model Indicator identifying how to store and transfer accounting records. At this point the Accounting Client instantiates a local representation of the accounting session in the form of a default UAE.

m) The xAN Accounting Client creates the DIAMETER Accounting_Request message of type START_Record and sends it to the LSF Accounting Server. This message indicates the beginning of an access session.

n) The LSF Accounting Server creates an initial SDR and stores it on local disk.

Access Session Accounting for Deregistration

This scenario demonstrates the accounting activities on MH deregistration. The two main activities shown are the sending of the STOP_Record to the LSF Accounting Server and the transfer of the SDR from the LSF to the NSF Accounting Server indicating a completed session.

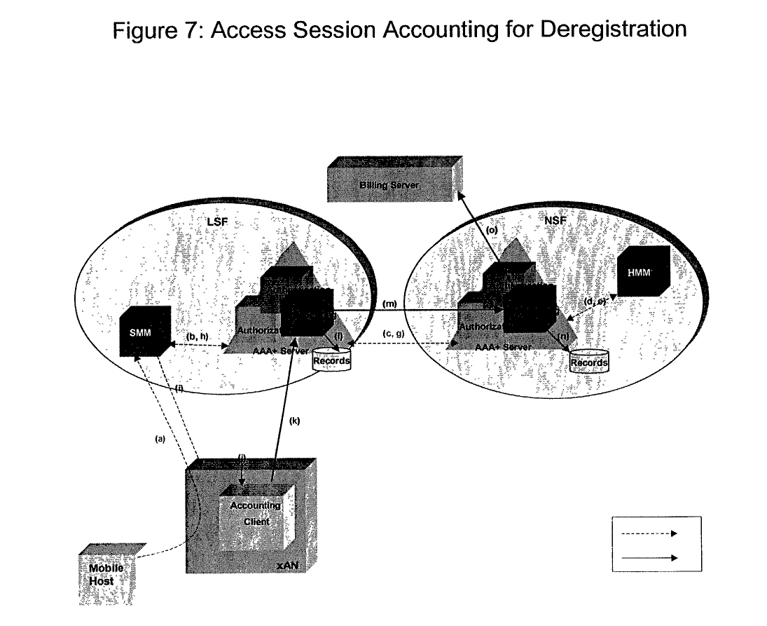

FIG. 7 illustrates access session accounting for deregistration and describes each step that takes place during this process.

a-i) The deregistration procedure is performed.

j) The deregistration reply message received by the xAN in step (i) triggers various de-allocation activities including the access session ended event being sent by the xAN Connection Manager to the Accounting Client.

k) The xAN Accounting Client creates the DIAMETER Accounting_Request message of type STOP_Record and sends it to the LSF Accounting Server. This message indicates the end of an access session. The STOP_Record contains all of the final usage data from the UAE representing this access session. The default UAE is then de-allocated.

l) The SDR is updated and stored on local LSF disk.

m) The SDR indicating a completed session is sent from the LSF Accounting Server to the home NSF Accounting Server.

n) The home NSF Accounting Server stores the SDR on disk.

o) The data is eventually transferred to the Billing Server (as provisioned by the service provider).

Implicit Request to Change QoS Through Allied Application Server

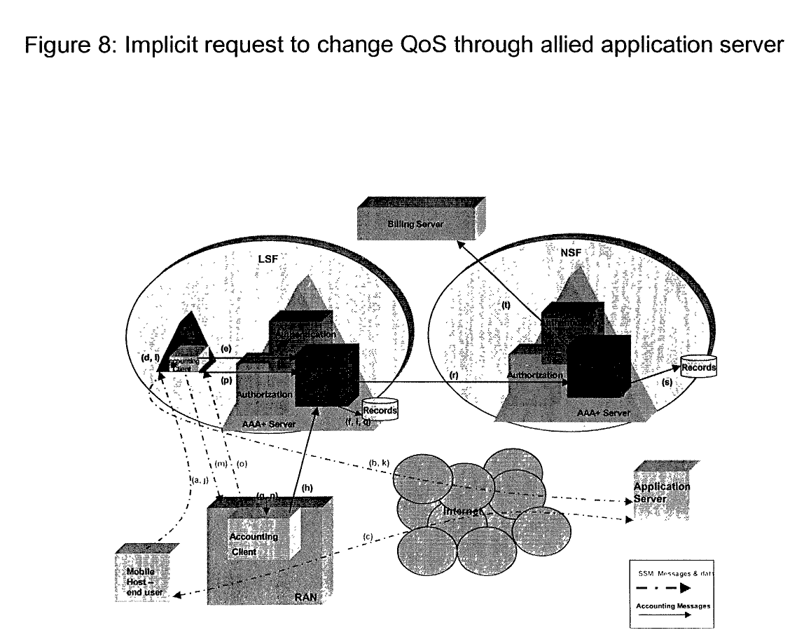

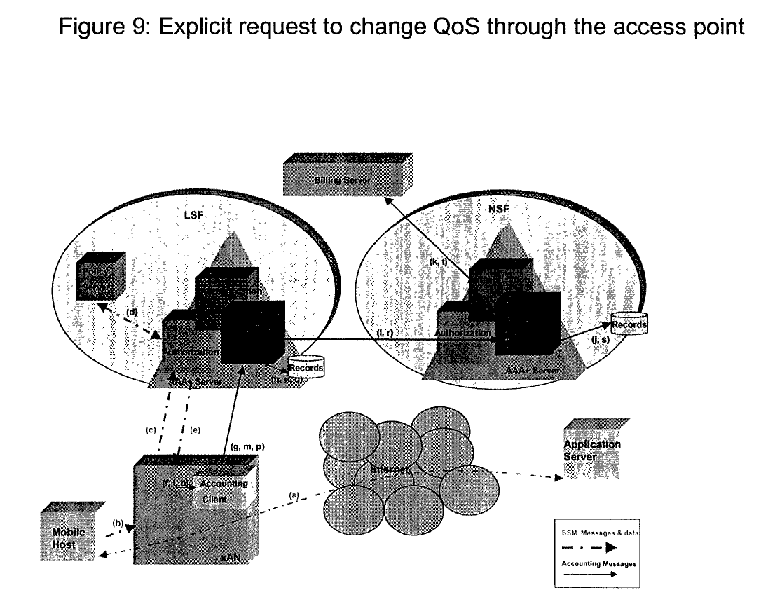

This scenario demonstrates the accounting activities on a service session invocation where the service is provided at the core network allied application server. The service is assumed to be provided using the default bandwidth and QoS granted during registration. However, core network allied application server in association with the core network components can alter the default bandwidth and QoS. In this scenario, accounting must be made at both the access network (e.g. RAN) for usage data such as bytes transmitted and received and at the core network allied application server (for example service invocation and duration). FIG. 8 describes each step that takes place during this process.

a) The service provided by the core network allied application server is invoked from the MH. At this point, the Accounting Model Indicator Establishment on Service Session Invocation procedure occurs as described in the referenced patent application Ser. No. ______ and is not repeated here for brevity. It is during this procedure that the service session UAE is instantiated at the RAN.

b) Session control and setup messaging occurs from the originator (core network allied application server) to the terminating application server residing somewhere on the Internet or another LSF.

c) The transport session bearer path is established between the MH and the terminating application server.

d) The Accounting Client within the Core network allied application server detects the service session invoked event and creates the SAE.

e) The Accounting Client within the Core network allied application server generates a DIAMETER Accounting_Request message of type Start_Record and sends it to the LSF Accounting Server to indicate start of service.

f) The LSF Accounting Server creates the SDR and stores it on local disk.

g) As data packets are transmitted and received over the bearer path, the transport session packets sent/rcvd event is detected within the RAN Accounting Client. The usage measurements for this session are captured in the RAN Accounting Client service session UAE.

h) The usage measurements are packaged in a DIAMETER Accounting_Request message of type Interim_Record and sent to the Accounting Server in the LSF. The interim data records may be batched or sent in real-time depending on the collection method defined for this service session by the Accounting Model Indicator.

i) The Interim_Record data is used to update the SDR on local LSF disk.

j) The service session ends by the MH.

k) Session control and de-allocation messaging occurs from the originator (Core network allied application server) to the terminating application server residing somewhere on the Internet or another LSF. The bearer path from c) is de-allocated.

l) The Accounting Client within the core network allied application server detects the service session ended event.

m) The application server (or another LSF session management component) sends a Resource De-allocation Request message to the Connection Manager in RAN.

n) The Accounting Client within the RAN detects the service session ended event.

o) The response to the Resource De-allocation Request message is sent from the RAN to the application server. This response includes the final usage data from the service session UAE within the RAN. The service session UAE is de-allocated.

p) The Accounting Client within the Core network allied application server generates a DIAMETER Accounting_Request message of type Stop_Record (containing the final usage data from the service session UAE and the final data from the SAE) and sends it to the LSF Accounting Server to indicate end of service. The SAE is de-allocated.

q) The SDR is updated and stored on local LSF disk.

r) The SDR indicating a completed service session is sent from the LSF Accounting Server to the home NSF Accounting Server.

s) The home NSF Accounting Server stores the SDR on disk.

t) The data is eventually transferred to the Billing Server (as provisioned by the service provider)

Explicit Request to Change QoS Through the Access Point

The scenario shown in FIG. 9 illustrates an explicit request to change QoS through the access point and demonstrates the accounting activities when a dynamic change in QoS is requested for an existing LSF service session. This is an event that requires the completion of the current session (with original QoS) and the beginning of a new session (with new QoS).

a) The Mobile Host has established an IP session with default QoS. However, the user determines that the granted QoS is insufficient.

b) The user requests a QoS change at the MH. The request is sent to the QoS controller in the xAN.

c) The xAN QoS Controller sends an Authorization Request to the Authorization Server in the LSF requesting authorization for the needed QoS.

d) The Policy Server is consulted for the requested QoS.

e) The request for authorization is approved and an acknowledgement is sent back to the QoS Controller in the xAN.

f) The QoS update during service session event is sent to the Accounting Client. A new service session UAE with the new QoS is established in the xAN.

g) The Accounting Client sends a DIAMETER Accounting_Request message including (1) a STOP_Record complete with final usage data for the original service session and (2) a START_Record for the new service session with approved QoS update and the same Accounting Session ID. The original service session UAE is de-allocated.

h) The SDR for the completed original service session is updated on local LSF disk. A new SDR for the new service session is created and stored on local disk.

i) The SDR (for the original service session) indicating a completed service session is sent from the LSF Accounting Server to the home NSF Accounting Server.

j) The home NSF Accounting Server stores the SDR on disk.

k) The data is eventually transferred to the Billing Server (as provisioned by the service provider).

I-t) For the new service session with the modified QoS, data packets are transmitted and received for the new service session, the transport session packets sent/rcvd event is detected within the xAN Accounting Client, the usage measurements of the new service session are captured in the new xAN Accounting Client UAE, INTERIM_Records and a STOP_Record are sent to the Accounting Server, SDRs are updated and sent to the NSF and made available to the Billing Server.

It is understood that several modifications, changes and substitutions are intended in the foregoing disclosure and in some instances some features of the invention will be employed without a corresponding use of other features. Accordingly, it is appropriate that the appended claims be construed broadly and in a manner consistent with the scope of the invention.

1. A method for a first user to communicate in an Internet Protocol (IP) centric distributed network with a plurality of service layers providing a plurality of functions associated with each of the service layers, the method comprising:
accessing the network to establish a point of presence at an access management layer and a core portion of the network and to designate a default amount of bandwidth and a plurality of default setup parameters;
invocating service through an application server on the network to establish an amount of network resources requested by the first user;
establishing a transport session to create and manage a connection from the first user to a destination address; and
accounting for a level of quality of service for a service session within the IP centric distributed network.

2. The method of claim 1 wherein the plurality of service layers includes a network service function layer.

3. The method of claim 1 wherein the plurality of service layers includes a local service function layer.

4. The method of claim 1 wherein the plurality of service layers includes an access service function layer.

5. The method of claim 3 further including distribution of client server functions within the local service layer.

6. The method of claim 1 further including distribution of client server functions within an access network.

7. The method of claim 1 wherein the accessing the network is done through an any access network (xAN).

8. The method of claim 1 wherein the accounting for a level of quality of service accomodates desired accounting parameters based on the level of quality of service requested.

9. The method of claim 1 herein the accounting for a level of quality of service accomodates modifying accounting parameters based on a dynamic change in the level of quality of service.

10. The method of claim 1 wherein the accounting for a level of quality of service supports mulitple simultaneous applications or services with respective levels of quality of service.

11. The method of claim 1 wherein the accounting for a level of quality of service dynamically segements and aligns billing information to accomodate dynamic changes in the level of quality of service.

12. The method of claim 1 further including requesting a quality of service change initiated from the first user.

13. The method of claim 12 further including communicating between an access point and a policy manager.

14. The method of claim 13 wherein the policy manager can be at the access point or at the core network.

15. The method of claim 12 further including creating a user accounting entry at the xAN, corresponding to the requested quaity of service and indicating allocated resources for the requested quality of service.

16. The method of claim 12 further including sending an accounting model indicator to the xAN.

17. The method of claim 12 further including sending an message to start a record from xAN to a accounting server at the local service layer.

18. The method of claim 12 further including updating a service detail record for the requested quality of service.

19. The method of claim 1 requesting a quality of service change initiated from a second user.

20. The method of claim 19 wherein the requested quality of service is initiated directly from the second user.

21. The method of claim 19 wherein the requested quality of service is initited indirectly by the second user and directly from a network that the second user is attached to.

22. The method of claim 19 further including requesting a quality of service change initiated from the second user.

23. The method of claim 22 further including communicating between an access point and a policy manager.

24. The method of claim 23 wherein the policy manager can be at the access point or at the core network.

25. The method of claim 19 further including creating a user accounting entry at the xAN, corresponding to the requested quaity of service and indicating allocated resources for the requested quality of service.

26. The method of claim 19 further including sending an accounting model indicator to the xAN.

27. The method of claim 19 further including sending an message to start a record from xAN to a accounting server at the local service layer.

28. The method of claim 19 further including updating a service detail record for the requested quality of service.

29. The method of claim 1 further including requesting a quality of service change initiated from an allied application server.

30. The method of claim 29 further including creating a service accounting entry at the allied application server indicating allocated services corresponding to the requested quality of service.

31. The method of claim 29 further including seind a message to start a recored from the allied application server to an accounting server at the local service layer.

32. The method of claim 29 further including udpating a service detail record corresoponding to a user accouting entry for the the requested quality of service, and wherein the user accounting entry is at the local service layer.

33. The method of claim 29 further including sending an accounting model indicator to the xAN.

34. The method of claim 29 further including creating a user accounting entry at the xAN to track useage specific to the requested quality of service.

35. The method of claim 1 further including dynamically changing the level of quality of service during an established service session.

36. The method of claim 35 further including sending a stop record with quality of service data corresponding to usage before the change in the level of quality of service.

37. The method of claim 36 further including de-allocating, from the xAN, an user accounting entry associated the usage before the change in the level of quality of service.

38. The method of claim 36 further including updating a service detail record at the local service layer.

39. The method of claim 36 further including sending a service detail record from an accounting server at the local service layer to an accounting server at the first user's network service layer.

40. The method of claim 39 further including storing the service detail record at the accounting server of the first user at the network service layer.

41. The method of claim 35 further including creating a user accounting entry at hte xAN to track usage specific to the change in the level of quality of service.

42. The method of claim 35 further including sending from the xAN, a start record message corresponding to the change in the level of quality of service to an accounting server at the local service layer.

43. The method of claim 35 futher including creating a service detail record at an accounting server at the local service layer with an identical session ID as a service detail record corresonding to the level of quality of service before the change.

44. The method of claim 1 further including dynamically changing the level of quality of service during an established service session at an application server on an Internet.

45. The method of claim 44 further including creating a user accounting entry at the xAN to track usage specific to the change in the level of quality of service.

46. The method of claim 44 further including sending from the xAN, a start record message corresponding to the change in the level of quality of service to an accounting server at the local service layer.

47. The method of claim 44 further including updating a service detail record at the local service layer.

48. A system for a first user to communicate in an Internet Protocol (IP) centric distributed network with a plurality of service layers providing a plurality of functions associated with each of the service layers, the system comprising:
a means for accessing the network to establish a point of presence at an access management layer and a core portion of the network and to designate a default amount of bandwidth and a plurality of default setup parameters;
an application server on the network that invocates service to establish an amount of network resources requested by the first user;
a means for establishing a transport session to create and manage a connection from the first user to a destination address; and
a means for accounting for a level of quality of service for a service session within the IP centric distributed network.

49. The system of claim 48 wherein the plurality of service layers includes a network service function layer.

50. The system of claim 48 wherein the plurality of service layers includes a local service function layer.

51. The system of claim 48 wherein the plurality of service layers includes an access service function layer.

52. The system of claim 50 further including client server functions distributed within the local service layer.

53. The system of claim 48 further including client server functions distributed within an access network.

54. The system of claim 48 wherein the accessing the network is done through an any access network (xAN).

55. The system of claim 1 wherein the means for accounting for a level of quality of service accomodates desired accounting parameters based on the level of quality of service requested.

56. The system of claim 48 wherein the means for accounting for a level of quality of service accomodates modifying accounting parameters based on a dynamic change in the level of quality of service.

57. The system of claim 48 wherein the means for accounting for a level of quality of service supports mulitple simultaneous applications or services with respective levels of quality of service.

58. The system of claim 48 wherein the means for accounting for a level of quality of service dynamically segements and aligns billing information to accomodate dynamic changes in the level of quality of service.

59. The system of claim 48 further including means for requesting a quality of service change initiated from the first user.

60. The system of claim 59 further including means for communicating between an access point and a policy manager.

61. The system of claim 60 wherein the policy manager can be at the access point or at the core network.

62. The system of claim 59 further including means for creating a user accounting entry at the xAN, corresponding to the requested quaity of service and indicating allocated resources for the requested quality of service.

63. The system of claim 59 further including means for sending an accounting model indicator to the xAN.

64. The system of claim 59 further including means for sending an message to start a record from xAN to a accounting server at the local service layer.

65. The system of claim 59 further including means for updating a service detail record for the requested quality of service.

66. The system of claim 48 means for requesting a quality of service change initiated from a second user.

67. The system of claim 66 wherein the requested quality of service is initiated directly from the second user.

68. The system of claim 67 wherein the requested quality of service is initited indirectly by the second user and directly from a network that the second user is attached to.

69. The system of claim 59 further including means for requesting a quality of service change initiated from the second user.

70. The system of claim 69 further including means for communicating between an access point and a policy manager.

71. The system of claim 70 wherein the policy manager can be at the access point or at the core network.

72. The system of claim 59 further including means for creating a user accounting entry at the xAN, corresponding to the requested quaity of service and indicating allocated resources for the requested quality of service.

73. The system of claim 69 further including means for sending an accounting model indicator to the xAN.

74. The system of claim 69 further including means for sending an message to start a record from xAN to a accounting server at the local service layer.

75. The system of claim 69 further including means for updating a service detail record for the requested quality of service.

76. The system of claim 48 further including means for requesting a quality of service change initiated from an allied application server.

77. The system of claim 76 further including means for creating a service accounting entry at the allied application server indicating allocated services corresponding to the requested quality of service.

78. The system of claim 76 further including means for sending a message to start a recored from the allied application server to an accounting server at the local service layer.

79. The system of claim 76 further including means for udpating a service detail record corresoponding to a user accouting entry for the the requested quality of service, and wherein the user accounting entry is at the local service layer.

80. The system of claim 76 further including means for sending an accounting model indicator to the xAN.

81. The system of claim 76 further including means for creating a user accounting entry at the xAN to track useage specific to the requested quality of service.

82. The system of claim 48 further including means for dynamically changing the level of quality of service during an established service session.

83. The system of claim 82 further including means for sending a stop record with quality of service data corresponding to usage before the change in the level of quality of service.

84. The system of claim 82 further including means for de-allocating, from the xAN, an user accounting entry associated the usage before the change in the level of quality of service.

85. The system of claim 82 further including means for updating a service detail record at the local service layer.

86. The system of claim 82 further including means for sending a service detail record from an accounting server at the local service layer to an accounting server at the first user's network service layer.

87. The system of claim 86 further including means for storing the service detail record at the accounting server of the first user at the network service layer.

88. The system of claim 82 further including means for creating a user accounting entry at hte xAN to track usage specific to the change in the level of quality of service.

89. The system of claim 82 further including means for sending from the xAN, a start record message corresponding to the change in the level of quality of service to an accounting server at the local service layer.

90. The system of claim 82 futher including means for creating a service detail record at an accounting server at the local service layer with an identical session ID as a service detail record corresonding to the level of quality of service before the change.

91. The system of claim 48 further including means for dynamically changing the level of quality of service during an established service session at an application server on an Internet.

92. The system of claim 91 further including means for creating a user accounting entry at the xAN to track usage specific to the change in the level of quality of service.

93. The system of claim 91 further including means for sending from the xAN, a start record message corresponding to the change in the level of quality of service to an accounting server at the local service layer.

94. The system of claim 91 further including means for updating a service detail record at the local service layer.

95. A method for a first user to communicate in an Internet Protocol (IP) centric distributed network with a plurality of service layers including a network service layer, a local service layer and an access network layer, providing a plurality of functions associated with each of the service layers, the method comprising:
accessing the network through an any access network (xAN) to establish a point of presence at an access management layer and a core portion of the network and to designate a default amount of bandwidth and a plurality of default setup parameters;
invocating service through an application server on the network to establish an amount of network resources requested by the first user;
establishing a transport session to create and manage a connection from the first user to a destination address; and
accounting for a level of quality of service for a service session within the IP centric distributed network.

96. The method of claim 95 wherein the accounting for a level of quality of service accomodates desired accounting parameters based on the level of quality of service requested.

97. The method of claim 95 wherein the accounting for a level of quality of service accomodates modifying accounting parameters based on a dynamic change in the level of quality of service.

98. The method of claim 95 wherein the accounting for a level of quality of service supports mulitple simultaneous applications or services with respective levels of quality of service.

99. The method of claim 95 wherein the accounting for a level of quality of service dynamically segements and aligns billing information to accomodate dynamic changes in the level of quality of service.

100. The method of claim 95 further including requesting a quality of service change initiated from the first user.

101. The method of claim 100 further including communicating between an access point and a policy manager.

102. The method of claim 102 wherein the policy manager can be at the access point or at the core network.

103. The method of claim 100 further including creating a user accounting entry at the xAN, corresponding to the requested quaity of service and indicating allocated resources for the requested quality of service.

104. The method of claim 100 further including sending an accounting model indicator to the xAN.

105. The method of claim 100 further including sending an message to start a record from xAN to a accounting server at the local service layer.

106. The method of claim 100 further including updating a service detail record for the requested quality of service.

107. The method of claim 95 requesting a quality of service change initiated from a second user.

108. The method of claim 107 wherein the requested quality of service is initiated directly from the second user.

109. The method of claim 107 wherein the requested quality of service is initited indirectly by the second user and directly from a network that the second user is attached to.

110. The method of claim 107 further including requesting a quality of service change initiated from the second user.

111. The method of claim 110 further including communicating between an access point and a policy manager.

112. The method of claim 111 wherein the policy manager can be at the access point or at the core network.

113. The method of claim 95 further including creating a user accounting entry at the xAN, corresponding to the requested quaity of service and indicating allocated resources for the requested quality of service.

114. The method of claim 113 further including sending an accounting model indicator to the xAN.

115. The method of claim 110 further including sending an message to start a record from xAN to a accounting server at the local service layer.

116. The method of claim 110 further including updating a service detail record for the requested quality of service.

117. The method of claim 95 further including requesting a quality of service change initiated from an allied application server.

118. The method of claim 117 further including creating a service accounting entry at the allied application server indicating allocated services corresponding to the requested quality of service.

119. The method of claim 117 further including seind a message to start a recored from the allied application server to an accounting server at the local service layer.

120. The method of claim 117 further including udpating a service detail record corresoponding to a user accouting entry for the the requested quality of service, and wherein the user accounting entry is at the local service layer.

121. The method of claim 117 further including sending an accounting model indicator to the xAN.

122. The method of claim 117 further including creating a user accounting entry at the xAN to track useage specific to the requested quality of service.

123. The method of claim 95 further including dynamically changing the level of quality of service during an established service session.

124. The method of claim 123 further including sending a stop record with quality of service data corresponding to usage before the change in the level of quality of service.

125. The method of claim 124 further including de-allocating, from the xAN, an user accounting entry associated the usage before the change in the level of quality of service.

126. The method of claim 123 further including updating a service detail record at the local service layer.

127. The method of claim 123 further including sending a service detail record from an accounting server at the local service layer to an accounting server at the first user's network service layer.

128. The method of claim 127 further including storing the service detail record at the accounting server of the first user at the network service layer.

129. The method of claim 123 further including creating a user accounting entry at hte xAN to track usage specific to the change in the level of quality of service.

130. The method of claim 123 further including sending from the xAN, a start record message corresponding to the change in the level of quality of service to an accounting server at the local service layer.

131. The method of claim 123 futher including creating a service detail record at an accounting server at the local service layer with an identical session ID as a service detail record corresonding to the level of quality of service before the change.

132. The method of claim 95 further including dynamically changing the level of quality of service during an established service session at an application server on an Internet.

133. The method of claim 132 further including creating a user accounting entry at the xAN to track usage specific to the change in the level of quality of service.

134. The method of claim 132 further including sending from the xAN, a start record message corresponding to the change in the level of quality of service to an accounting server at the local service layer.

135. The method of claim 132 further including updating a service detail record at the local service layer.
